(19) United States
(12) Patent Application Publication
(10) Pub. No.: US 2022/0155847 A1
(43) Pub. Date: May 19, 2022

(54) TECHNOLOGIES FOR A PROCESSOR TO ENTER A REDUCED POWER STATE WHILE MONITORING MULTIPLE ADDRESSES

(71) Applicant: Intel Corporation, Santa Clara, CA (US)

(72) Inventors: Konstantin ANANYEV, NAAS (IE); Anatoly BURAKOV, Shannon (IE); David HUNT, Meelick (IE); Chris MACNAMARA, Limerick (IE); Edwin VERPLANKE, Chandler, AZ (US); Omkar MASLEKAR, Chandler, AZ (US); Gilbert NEIGER, Portland, OR (US); Rajesh M. SANKARAN, Portland, OR (US)

(21) Appl. No.: 17/559,170

(22) Filed: Dec. 22, 2021

Related U.S. Application Data
(60) Provisional application No. 63/184,003, filed on May 4, 2021.

(51) Int. Cl. G06F 1/3296; G06F 3/06

(52) U.S. Cl. CPC G06F 1/3296; G06F 3/0673; G06F 3/0659; G06F 3/0625

(57) ABSTRACT

Examples described herein relate to circuitry to cause a processor to enter reduced power consumption state and circuitry to, based on a write to one or more of multiple memory regions, cause the processor to exit reduced power consumption state, wherein the multiple memory regions store receive descriptors associated with one or more packets received by a network interface device. In some examples, multiple memory regions are defined by a driver of the network interface device. In some examples, the reduced power consumption state comprises a TPAUSE state.

### RELATED APPLICATION

This application claims priority to U.S. Provisional Application No. 63/184,003, filed May 4, 2021. The entire contents of that application are incorporated by reference in its entirety.

In communications workloads, a common method of receiving packets involves a central processing unit (CPU) core continuously polling a memory location waiting for it to change to identify traffic arriving from a network interface or another core. In Data Plane Development Kit (DPDK), packet processing in user space takes place but utilizes polling for received packets. CPU cycles are spent polling that could be used for other purposes.

### BRIEF DESCRIPTION OF THE DRAWINGS

FIG. 1 depicts an example system.

FIG. 2 depicts an example process.

FIG. 3 depicts an example process.

FIG. 4 depicts an example operation.

FIG. 5 depicts a system.

### DETAILED DESCRIPTION

Intel® Restricted Transactional Memory(®) provides instructions (e.g., XBEGIN, XEND, XABORT, XTEST) that allow a processor core to start, end, or abort execution of a transaction. Memory addresses read-from within a transactional region can include a read-set of the transactional region. Addresses read from inside the transactional region are added to a read-set. Addresses written-to inside the transaction region are added to a write-set. External write to both read-set or write-set can cause the transaction to abort. For example, if another processor or device writes to memory that is part of a read-set or a write-set, a transaction abort will occur. For example, Intel® Restricted Transactional Memory(RTM) can permit read-sets and write-sets at a granularity of a CPU cache line.

Intel® WAITPKG provides instructions (e.g., UMONITOR/UMWAIT and TPAUSE), that when executed, cause the processor to enter a reduced power consumption state. The processor that executed a TPAUSE instruction can wake-up either due to the expiration of the time-limit, or due to one or more of the following events: a store to the read-set or write-set range within the transactional region, a non-maskable interrupt (NMI), System Management Interrupt (SMI), a debug exception, a machine check exception, and so forth. In some examples, for ARM-based processors, ARM wake for event (WFE) can be used to cause a processor, that is in lower power state, to return to a higher power state.

To save power while waiting for new packet arrivals, the Intel® UMONITOR/UMWAIT instructions allow the core to wait in implementation-dependent lower power state until a write to a specific address has occurred. Execution of UMONITOR/UMWAIT instructions causes a processor core, in a low power mode, to wait for a single address to be written-to in order to increase power usage and perform a process.

TPAUSE mode allows a processor core to enter low power mode and wake the processor core after expiration of a timer. When TPAUSE is used in conjunction with Restricted Transactional Memory(RTM), a write to any one of multiple addresses in a transaction read-set causes an RTM transaction abort, causing the TPAUSE to exit and the processor core to wake-up, thereby prematurely causing the processor core to exit low power state.

A processor that performs packet processing, or other activities in response to the occurrence of one or more hardware events, can enter lower power state to reduce power usage, and wait for one or more hardware events indicative of packet processing work to be performed. A processor can enter low power state and monitor writes to multiple memory addresses for one or more hardware or software events. A write to an address in the multiple memory addresses can cause a transactional abort and wake the processor from sleep or lower power state, to respond to the occurrence of one or more hardware events and perform a process (e.g., processing a received packet).

Examples described herein to wake a processor can be used with processors that perform instructions consistent with one or more of: x86 instruction set (with some extensions that have been added with newer versions); the MIPS instruction set; the ARM instruction set (with optional additional extensions such as NEON); reduced instruction set computer (RISC); RISC-V, complex instruction set computing (CISC); very long instruction word (VLIW); or a hybrid or alternative core type.

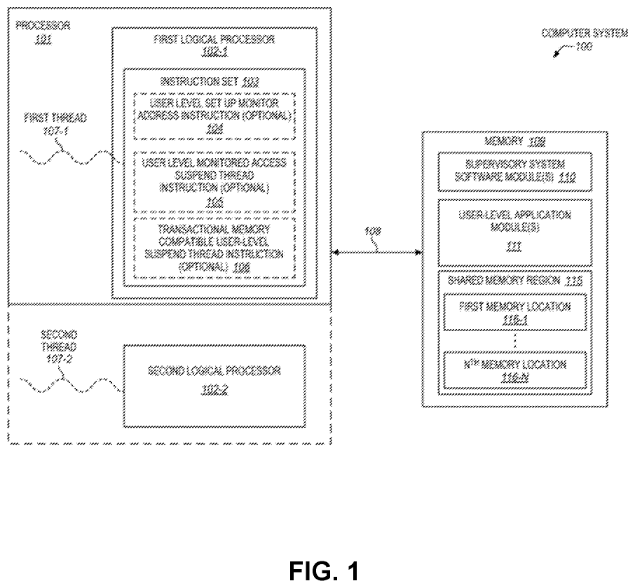

FIG. 1 depicts an example system. The system includes at least one processor 101. The processor 101 is coupled with, or otherwise in communication with, a memory 109 by a coupling mechanism 108. The memory may include one or more memory devices of the same or different types. Various conventional ways of coupling a processor with a memory are suitable. For example, the coupling mechanism may include one or more buses, hubs, memory controllers, chipset components, or the like, and various combinations thereof. In various embodiments, the computer system may represent a desktop computer, a laptop computer, a notebook computer, a tablet computer, a netbook, a smartphone, a server, a network device (e.g., a router, switch, etc.), or other type of system having one or more processors.

Processor 101 includes at least a first logical processor 102-1. The processor 101 may optionally include the first logical processor 102-1 as a single logical processor, or the processor may optionally include multiple such logical processors. The computer system also includes at least a second logical processor 102-2, and may optionally include other logical processors. Dashed lines are used to show that the second logical processor may either be part of the processor 101, or may be external to the processor 101. By way of example, the second logical processor, may optionally be included on a second processor (e.g., a second die) or in another component (e.g., a direct memory access (DMA) device).

Examples of suitable types of logical processors include, but are not limited to, single threaded cores, hardware threads, thread units, thread slots, logical processors having dedicated context or architectural state storage and a program counter, logical processors having dedicated context or architectural state storage and a program counter on which software may be independently scheduled on, and the like. The term core is often used to refer to logic located on an integrated circuit that is capable of maintaining an independent architectural state (e.g., an execution state), and in which the architectural state is associated with dedicated execution and certain other dedicated resources. In contrast, the term hardware thread is often used to refer to logic located on an integrated circuit that is capable of maintaining an independent architectural state, and in which the architectural state shares access to execution and certain other resources. Depending on which resources are shared and dedicated in a given implementation the line between such usage of the terms core and hardware thread may tend to be less distinct. Nevertheless, the cores, hardware threads, and other logical processors are generally viewed by software as individual logical processors or processor elements. Generally, software (e.g., software threads, processors, workloads, or the like) may be scheduled on, and independently associated with, each of the logical processors.

The memory may store one or more supervisory system software modules 110, for example, one or more operating system modules, one or more virtual machine monitor modules, one or more hypervisors, or the like. The memory may also store one or more user-level application modules 111. During operation, the supervisory system software module(s) may schedule a first software thread 107-1 on the first logical processor, and schedule a second software thread 107-2 on the second logical processor.

While running, the first and second software threads 107 may be operative to access a shared memory region 115. As shown, the shared memory region may include a first shared memory location 116-1 through an Nth shared memory location 116-N, where the number N may represent any reasonable number appropriate for the particular implementation. The shared memory locations may optionally also be shared by other software threads. In some cases, the first software thread may monitor and detect when the second software thread (or another software thread) has written to and/or modified one or more of these multiple memory locations. As one illustrative example, this may be the case in conjunction with synchronization. The second software thread (or another software thread) may modify a memory location when there is work for the first software thread to do, and the first software thread may want to be able to monitor the memory location, so that it can determine when there is available work to perform.

First logical processor 102-1 has an instruction set 103. In some embodiments, the instruction set may include an embodiment of an optional user-level set up monitor address instruction 104, an embodiment of an optional user-level monitored access suspend thread instruction 105, and an embodiment of an optional transactional memory compatible user-level suspend thread instruction 106. In some embodiments, the instruction set may include as few as only any one of these instructions. The instructions 104, 105, 106 are user-level instructions, which may be performed at user-level privilege, as well as at higher privilege levels (e.g., by supervisory system software). In some embodiments, the user-level monitored access suspend thread instruction 105 may allow user-level software (e.g., one of the user-level application module(s) 111) to suspend a thread, and use a monitor mechanism, which has been set up by the user-level set up monitor address instruction 104, to know when one of the shared memory locations 115 has been accessed.

Advantageously, there may be no need to perform an idle, busy, or other loop, or even perform any subsequent instructions. In addition, since the user-level monitored access suspend thread instruction is a user-level instruction, which are allowed to be performed at user-level privilege (as well as at higher privilege levels), there is no need or requirement for a user-level application (e.g., one of the user-level application module(s) 111) to yield or otherwise transition to supervisory system software (e.g., one of the supervisory system software modules 110), in order for the instruction to be performed. Rather, the instruction may be performed while in, and without leaving, the user-level privilege, and without needing to perform a ring transition or other transition to a higher level of privilege.

A driver associated with a network interface device driver can be executed by a processor can indicate a memory address range that stores RX descriptor ring. A process can define memory regions of a transactional region by reading from memory addresses that correspond to a stored receive (RX) descriptor ring. A transaction can include one or more processor-executable instructions. A transaction abort can occur based on a write to a memory region within the transactional region. A core can be awaken from lower power state (e.g., TPAUSE) in response to a transaction abort. A process can execute a transaction that reads values from the memory region that corresponds to a receive descriptor ring that is written to. An end of a successful transaction can correspond to reading an entire memory region with no writes to the memory region and timer expiring.

Using XBEGIN and XEND, a write to an address in the transactional read set causes a transaction abort (e.g., tells core transaction there was a write to a region and region has changed), which causes core to exit TPAUSE. A value written to an address in the transactional read set that changes a value associated with an address could trigger exit from TPAUSE. For example, a write to an address can indicate a new packet is available to process. At transaction abort, a core can perform an instruction set (e.g., process packet).

A transaction abort can cause a restart of the transaction. For example, the transaction can restart at XBEGIN. At or after the restart of a transaction, a value can be read that indicates whether a prior transaction was aborted. If the prior transaction was aborted, then the transaction can end. If the prior transaction was not aborted, then the transaction can proceed from its start. A prior transaction abort can be indicated by the CPU in some examples. When an abort occurs, the actual sequence of events can occur: attempt to start a transaction, transaction started successfully, event causes transaction abort, roll back as though transaction has not started before, attempt to start a transaction, do not start transaction because it was previously aborted.

In some examples, prior to a decision to enter lower power state, a process can check whether a new RX descriptor was written to an RX descriptor ring. The process can query the driver to indicate whether the RX descriptor ring changed since a prior query. Before entering a transaction, the process can check if the RX descriptor ring changed since a prior query at a start of a transaction. If the RX descriptor ring changed, the transaction can be aborted and the process can process the RX descriptor and the transaction can be identified as aborted. At a point of CPU executing instructions one by one, a memory location can potentially be overwritten by another CPU core, a DMA from a network interface device, etc. With transactional memory, hardware can detect attempts to overwrite memory designated as monitored by reading the memory, but can only do so after monitored memory addresses are added to the read set. For example, in the following scenario.

Thread A: stores state about memory location A
Thread A: stores state about memory location B
Thread A: stores state about memory location C
Thread A: enters our power save routine
Thread A: enters transactional region
Thread A: reads memory location A (adding it to the read set)
Thread A: reads memory location B (adding it to the read set)
Thread B: overwrites memory location C
Thread A: reads memory location C (adding it to the read set)

In the above scenario, even a transactional region is used, adding things to the read set still takes non-zero amount of time, and there is still potential to overwrite data that is about to be read. A check can be performed right before starting a transaction and after inside the transaction to determine if data was overwritten. Software can check guarantees that data in memory location C did not change memory location C was added to the read set. Hardware can check that data in memory location C does not change after memory location C was added to the read set.

The RX descriptor can refer to a packet stored in a packet buffer by a network interface device.

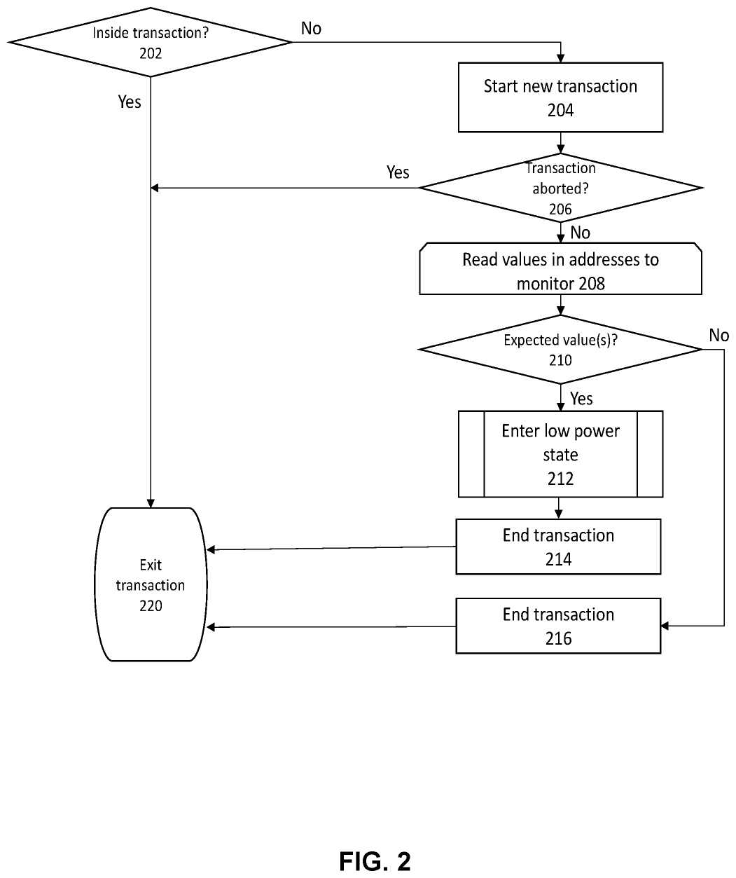

FIG. 2 depicts a process that can be performed by a core or processor. The process can be implemented as part of packet processing software based on DPDK running in user space.

At 202, based on being outside of an active nested transactional region (e.g., a transaction inside another transaction), the process can proceed to 204. XTEST is a CPU instruction that identifies whether a process is inside a transactional region, and, if the process starts, the process is a nested transaction). Although examples herein relate to use of XTEST( ), XTEST is not required and other nested transactional regions can be used.

At 204, a transactional region can be identified. A start of a transactional region can be identified using XBEGIN. Addresses that CPU core reads-from are in the transactional read-set. The transactional read-set can correspond to a receive descriptor ring. Until end of a nested transactional region (e.g., instruction to end transaction (XEND)), a write by a device (e.g., Intel® Data Direct I/O Technology (DDIO) by a network interface device, an accelerator device, or write by a core) to an address in the transactional read-set can cause transactional abort (e.g., exit from TPAUSE).

At 206, a check can be made to determine if the core is to abort entering low power state. In some cases, during setting up monitoring for hardware events, by the time addresses are added into a read-set, writes to addresses may have already happened, such as newly added one or more RX descriptors. For example, one of the read-set addresses may have been written-to before the start of the transaction (e.g., before execution of XBEGIN) and a check is made to determine if a newly received packet is identified by an RX descriptor. To prevent cores from entering power-optimized state (e.g., lower power state) when the core is to perform work, such as packet processing, at 206, values at the addresses can be read and checked if there was no change in RX descriptor ring content from when start adding addresses to read-set. For example, if the RX descriptor ring did not change from when addresses started to be added to a read-set, the process can proceed to 208. For example, an unexpected value can occur if a write occurred to a monitored address. If an RX descriptor was added, entering of power-optimized state is aborted, and the process can proceed to 216.

In some cases, a hardware device, e.g., a CPU can abort a transaction at after a transaction has started based on detecting a prior transaction aborted. A transaction termination or abort can be triggered by a CPU. After abort of a transaction, execution can revert back to the start of the transaction, and checks can occur if a transaction abort occurred previously. If a prior transaction aborted, the current instance of the transaction can abort as well.

At 208, a core can enter reduced power state (e.g., sleep state) and the transaction process executed by the core can read values in the addresses of the read-set addresses. A lower power state can be C0.1 or C0.2 which is light sleep with fast wake up mode to go to state C0. At 210, based on values in the read-set being expected values, indicating no new packet arrival, the process can proceed to 212. Values in an Rx descriptor ring may change but not necessarily indicate new packet arrival. While inside transactional region, driver software can decide whether the value read from the descriptor ring is sufficiently different to trigger premature transaction end. However, based on a value in the read-set being an unexpected value, indicating the RX descriptor ring has been updated, the transaction can proceed to 216. A subsequent write to an address in the transactional read set by a device (e.g., Intel® Data Direct I/O Technology (DDIO) by a network interface device, an accelerator device, or write by a core) can cause wake-up of the core that is associated with the address.

At 212, the core can enter reduced power state. For example, to enter reduced power state, the core can execute a TPAUSE instruction. TPAUSE is a low energy polling by core of the one or more addresses.

At 214, after completion of the transaction, namely, reading addresses of an entire read-set region with no writes to the memory region and a timer expiring. The transaction that reaches end can be identified as successful. The completion of a transaction can be identified using XEND.

At 216, the transaction can end and be identified as aborted. The core can process one or more packets or other content. If the contents of an address indicate a packet is present (e.g., a non-null value, or a value with a specific bit set to indicate valid data/packet), the core can process one or more packets or other content. At 220, transactional region can end.

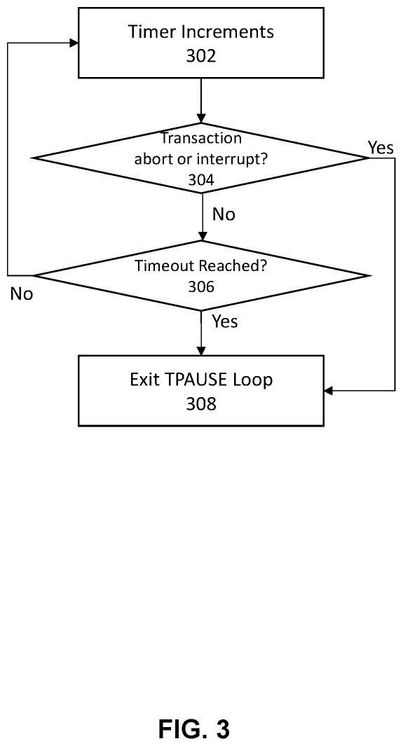

FIG. 3 depicts a process that can determine whether to exit TPAUSE based on expiration of a timer. At 302, the timer can commence incrementing to an upper limit value or decrementing to a lower limit value. A transaction could cause TPAUSE state of a core can be set for a timer limit. At 304, if a transaction aborts (e.g., write to address in transactional region) or, at 306, if the timer limit is reached, then at 308, the TPAUSE can be exited and the core can perform a code segment. At 304, if a transaction does not abort or, at 306, the timer limit is not reached, then the process can return to 302.

The following is a simplified pseudocode.

| | |
|---|---|
| XBEGIN( ); | // start RTM transaction |

read all monitored addresses; // this will populate the read-set
if (write already happened)

| | |
|---|---|
| goto end; | // sleep was not needed |
| tpause( ); | // go into power optimized state, wake up on |
| | writes to read-set |
| :end | |

XEND( ); // end RTM transaction

### EXAMPLE CODE SEGMENT

The following provides an example of a code segment in C language, in accordance with some embodiments.

```
void
monitor_multiple(const struct monitor_condition mc[ ],
    const uint32_t num_conditions)
{
  uint32_t i, rc;
  /* start new transaction region */
  rc = xbegin( );
  /* transaction abort, possible write to one of wait addresses */
  if (rc != XBEGIN_STARTED)
    return;
  /*
  * add all addresses to wait on into transaction read-set and check if
  * any of wakeup conditions are already met.
  */
  for (i = 0; i < num; i++) {
    const struct monitor_condition *c = &mc[i];
    /* act of reading adds the value to the transaction read-set */
      const uint64_t val = read_current_value(c);
      if (val == expected_val)
        break;
  }
  /* none of the conditions were met, enter TPAUSE sleep */
  if (i == num)
      tpause( );
  /* end transaction region */
  xend( );
}
```

The following code starts a transaction, and checks the result. When a transactional abort happens, a jump back to the beginning of the transaction occurs, and the rc value indicates whether the transaction was started, or whether it was aborted (or not started for any other reason). So, whenever transaction abort happens, the execution jumps back to where the transaction started (xbegin( )), but this time with a different rc value.

/* start new transaction region */
rc = xbegin( );
/* transaction abort, possible write to one of wait addresses */
if (rc != XBEGIN_STARTED)
return;

The following code checks if writes waited for have already happened before the transaction started. If they did not, it would be equal to num (the loop did not stop prematurely), and a processor can sleep with TPAUSE. If writes have already happened prior to transactional region start, the processor does not sleep.

```
/*
* add all addresses to wait on into transaction read-set and check if
* any of wakeup conditions are already met.
*/
for (i = 0; i < num; i++) {
  const struct monitor_condition *c = &mc[i];
  /* act of reading adds the value to the transaction read-set */
  const uint64_t val = read_current_value(c);
  if (val == expected_val)
    break;
}
/* none of the conditions were met, enter TPAUSE sleep */
if (i == num)
  tpause( );
```

The following code marks the end of the transactional region, and this is reached in cases when no transactional aborts happened at any point during the transactional region. If a transaction abort happens, this line is not reached and instead code jumps back to xbegin( ) with a flag set to indicate that transaction has aborted.

/* end transaction region */
xend( );

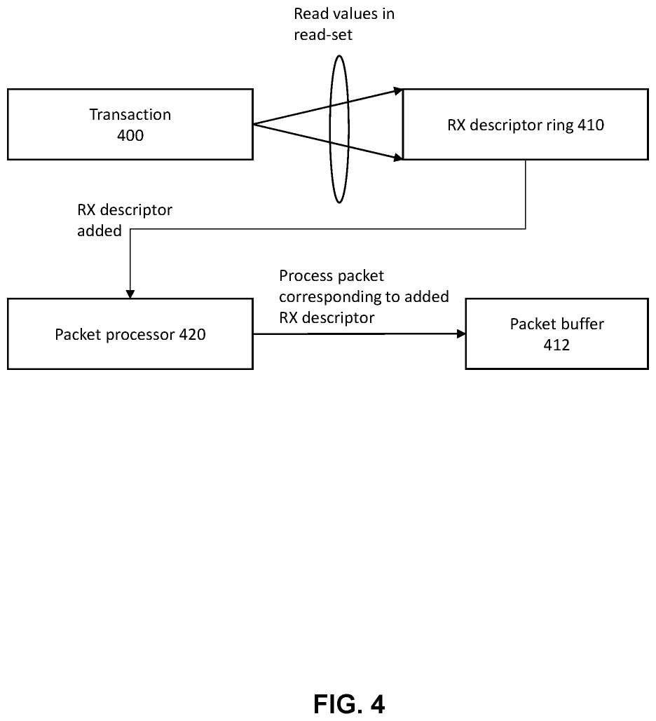

FIG. 4 depicts an example operation. Transaction 400 can read an RX descriptor ring 410 that corresponds to a read-set. The addresses in the read-set corresponding to the RX descriptor ring can be made available by a network interface device driver. Based on an addition of an RX descriptor to RX descriptor ring 410, the transaction 400 can abort and packet processor 420 can process a packet associated with the added RX descriptor in packet buffer 412.

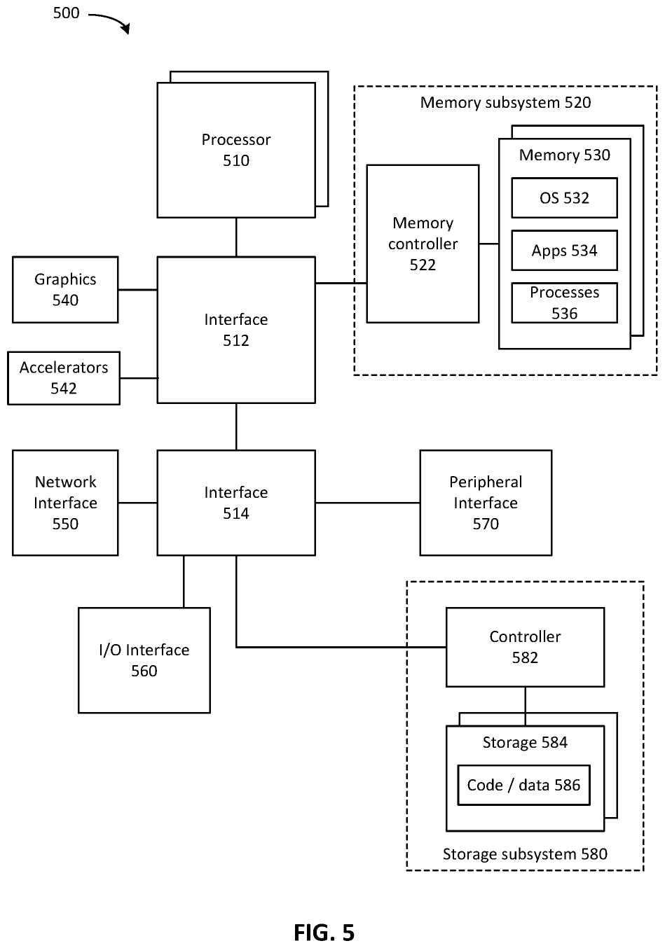

FIG. 5 depicts an example computing system. Components of system 500 (e.g., processor 510, network interface 550, and so forth) can be configured to enter reduce power mode and monitor multiple addresses for new receive descriptors indicating received packets to process, as described herein. System 500 includes processor 510, which provides processing, operation management, and execution of instructions for system 500. Processor 510 can include any type of microprocessor, central processing unit (CPU), graphics processing unit (GPU), processing core, or other processing hardware to provide processing for system 500, or a combination of processors.

As described herein, processor 510 can execute instructions that cause processor 510 to enter a reduced power state and execute a transaction to read multiple addresses and wake-up from reduced power state to process a packet based on detecting a new receive descriptor indicative of a received packet to process.

Processor 510 controls the overall operation of system 500, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 500 includes interface 512 coupled to processor 510, which can represent a higher speed interface or a high throughput interface for system components that needs higher bandwidth connections, such as memory subsystem 520 or graphics interface components 540, or accelerators 542. Interface 512 represents an interface circuit, which can be a standalone component or integrated onto a processor die. Where present, graphics interface 540 interfaces to graphics components for providing a visual display to a user of system 500. In one example, graphics interface 540 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 540 generates a display based on data stored in memory 530 or based on operations executed by processor 510 or both. In one example, graphics interface 540 generates a display based on data stored in memory 530 or based on operations executed by processor 510 or both.

Accelerators 542 can be a fixed function or programmable offload engine that can be accessed or used by a processor 510. For example, an accelerator among accelerators 542 can provide compression (DC) capability, cryptography services such as public key encryption (PKE), cipher, hash/authentication capabilities, decryption, or other capabilities or services. In some embodiments, in addition or alternatively, an accelerator among accelerators 542 provides field select controller capabilities as described herein. In some cases, accelerators 542 can be integrated into a CPU socket (e.g., a connector to a motherboard or circuit board that includes a CPU and provides an electrical interface with the CPU). For example, accelerators 542 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 542 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 520 represents the main memory of system 500 and provides storage for code to be executed by processor 510, or data values to be used in executing a routine. Memory subsystem 520 can include one or more memory devices 530 such as read-only memory (ROM), flash memory, one or more varieties of random access memory (RAM) such as DRAM, or other memory devices, or a combination of such devices. Memory 530 stores and hosts, among other things, operating system (OS) 532 to provide a software platform for execution of instructions in system 500. Additionally, applications 534 can execute on the software platform of OS 532 from memory 530. Applications 534 represent programs that have their own operational logic to perform execution of one or more functions. Processes 536 represent agents or routines that provide auxiliary functions to OS 532 or one or more applications 534 or a combination. OS 532, applications 534, and processes 536 provide software logic to provide functions for system 500. In one example, memory subsystem 520 includes memory controller 522, which is a memory controller to generate and issue commands to memory 530. It will be understood that memory controller 522 could be a physical part of processor 510 or a physical part of interface 512. For example, memory controller 522 can be an integrated memory controller, integrated onto a circuit with processor 510.

In some examples, OS 532 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Nvidia®, Qualcomm®, IBM®, Texas Instruments®, among others. In some examples, a driver associated with network interface 550 can indicate, to a process, a memory address range that stores RX descriptor ring and the memory address range can be monitored by processor 510, in low power state, to determine if a received packet is provided by network interface 550, as described herein. Based on a identifying an indication a received packet is available to process, processor 510 can exit low power state and process the received packet.

Applications 534 and/or processes 536 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

A virtual machine (VM) can be software that runs an operating system and one or more applications. A VM can be defined by specification, configuration files, virtual disk file, non-volatile random access memory (NVRAM) setting file, and the log file and is backed by the physical resources of a host computing platform. A VM can include an operating system (OS) or application environment that is installed on software, which imitates dedicated hardware. The end user has the same experience on a virtual machine as they would have on dedicated hardware. Specialized software, called a hypervisor, emulates the PC client or server's CPU, memory, hard disk, network and other hardware resources completely, enabling virtual machines to share the resources. The hypervisor can emulate multiple virtual hardware platforms that are isolated from another, allowing virtual machines to run Linux®, Windows® Server, VMware ESXi, and other operating systems on the same underlying physical host.

A container can be a software package of applications, configurations and dependencies so the applications run reliably on one computing environment to another. Containers can share an operating system installed on the server platform and run as isolated processes. A container can be a software package that contains everything the software needs to run such as system tools, libraries, and settings. Containers may be isolated from the other software and the operating system itself. The isolated nature of containers provides several benefits. First, the software in a container will run the same in different environments. For example, a container that includes PHP and MySQL can run identically on both a Linux® computer and a Windows® machine. Second, containers provide added security since the software will not affect the host operating system. While an installed application may alter system settings and modify resources, such as the Windows registry, a container can only modify settings within the container.

While not specifically illustrated, it will be understood that system 500 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 500 includes interface 514, which can be coupled to interface 512. In one example, interface 514 represents an interface circuit, which can include standalone components and integrated circuitry. In one example, multiple user interface components or peripheral components, or both, couple to interface 514. Network interface 550 provides system 500 the ability to communicate with remote devices (e.g., servers or other computing devices) over one or more networks. Network interface 550 can include an Ethernet adapter, wireless interconnection components, cellular network interconnection components, USB (universal serial bus), or other wired or wireless standards-based or proprietary interfaces. Network interface 550 can transmit data to a device that is in the same data center or rack or a remote device, which can include sending data stored in memory.

Network interface 550 can include one or more of: a network interface controller (NIC), a remote direct memory access (RDMA)-enabled NIC, SmartNlC, router, switch, or network-attached appliance. Some examples of network interface 550 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

In one example, system 500 includes one or more input/output (I/O) interface(s) 560. I/O interface 560 can include one or more interface components through which a user interacts with system 500 (e.g., audio, alphanumeric, tactile/touch, or other interfacing). Peripheral interface 570 can include any hardware interface not specifically mentioned above. Peripherals refer generally to devices that connect dependently to system 500. A dependent connection is one where system 500 provides the software platform or hardware platform or both on which operation executes, and with which a user interacts.

In one example, system 500 includes storage subsystem 580 to store data in a nonvolatile manner. In one example, in certain system implementations, at least certain components of storage 580 can overlap with components of memory subsystem 520. Storage subsystem 580 includes storage device(s) 584, which can be or include any conventional medium for storing large amounts of data in a nonvolatile manner, such as one or more magnetic, solid state, or optical based disks, or a combination. Storage 584 holds code or instructions and data 586 in a persistent state (e.g., the value is retained despite interruption of power to system 500). Storage 584 can be generically considered to be a “memory,” although memory 530 is typically the executing or operating memory to provide instructions to processor 510. Whereas storage 584 is nonvolatile, memory 530 can include volatile memory (e.g., the value or state of the data is indeterminate if power is interrupted to system 500). In one example, storage subsystem 580 includes controller 582 to interface with storage 584. In one example controller 582 is a physical part of interface 514 or processor 510 or can include circuits or logic in both processor 510 and interface 514.

A volatile memory is memory whose state (and therefore the data stored in it) is indeterminate if power is interrupted to the device. Dynamic volatile memory uses refreshing the data stored in the device to maintain state. One example of dynamic volatile memory incudes DRAM (Dynamic Random Access Memory), or some variant such as Synchronous DRAM (SDRAM). An example of a volatile memory include a cache. A memory subsystem as described herein may be compatible with a number of memory technologies, such as those consistent with specifications from JEDEC (Joint Electronic Device Engineering Council) or others or combinations of memory technologies, and technologies based on derivatives or extensions of such specifications.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), Intel® Optane™ memory, NVM devices that use chalcogenide phase change material (for example, chalcogenide glass), a combination of one or more of the above, or other memory.

A power source (not depicted) provides power to the components of system 500. More specifically, power source typically interfaces to one or multiple power supplies in system 500 to provide power to the components of system 500. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 500 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMB A) interconnect, OpenCAPI, Gen-Z, Infinity Fabric (IF), Cache Coherent Interconnect for Accelerators (COX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

Embodiments herein may be implemented in various types of computing, smart phones, tablets, personal computers, and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

In some examples, network interface and other embodiments described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), on-premises data centers, off-premises data centers, edge network elements, fog network elements, and/or hybrid data centers (e.g., data center that use virtualization, cloud and software-defined networking to deliver application workloads across physical data centers and distributed multi-cloud environments).

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of steps may also be performed according to alternative embodiments. Furthermore, additional steps may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.′”

Illustrative examples of the devices, systems, and methods disclosed herein are provided below. An embodiment of the devices, systems, and methods may include any one or more, and any combination of, the examples described below.

Example 1 includes one or more examples, and includes an apparatus comprising: circuitry to cause a processor to enter reduced power consumption state and circuitry to, based on a write to one or more of multiple memory regions, cause the processor to exit reduced power consumption state, wherein the multiple memory regions store receive descriptors associated with one or more packets received by a network interface device.

Example 2 includes one or more examples, wherein the multiple memory regions are defined by a driver of the network interface device.

Example 3 includes one or more examples, wherein the reduced power consumption state comprises a TPAUSE state.

Example 4 includes one or more examples, wherein the processor is to execute a transaction that reads from the multiple memory regions and wherein the transaction comprises one or more instructions.

Example 5 includes one or more examples, wherein the transaction commences at XBEGIN and ends at XEND.

Example 6 includes one or more examples, wherein the transaction is to abort based on a prior aborted transaction.

Example 7 includes one or more examples, wherein the transaction completes based on read from the multiple memory regions, no update to the multiple memory regions, and expiration of a timer.

Example 8 includes one or more examples, wherein based on exit from reduced power consumption state, the processor is to execute a packet processing process to process a packet associated with at least one or the receive descriptors.

Example 9 includes one or more examples, and a network interface device to indicate receipt of the one or more packets.

Example 10 includes one or more examples, and includes a data center comprising a server to transmit the one or more packets to the network interface device.

Example 11 includes one or more examples, and includes a computer-readable medium comprising instructions stored thereon, that if executed by one or more processors, cause the one or more processors to: enter reduced power consumption state and based on a write to one or more of multiple memory regions, exit reduced power consumption state, wherein the multiple memory regions store receive descriptors associated with one or more packets received by a network interface device.

Example 12 includes one or more examples, wherein the multiple memory regions are defined by a driver of the network interface device.

Example 13 includes one or more examples, wherein the reduced power consumption state comprises a TPAUSE state.

Example 14 includes one or more examples, wherein, in reduced power consumption state, the one or more processors are to execute a transaction that reads from the multiple memory regions.

Example 15 includes one or more examples, wherein the transaction commences at XBEGIN and ends at XEND.

Example 16 includes one or more examples, wherein the transaction is to abort based on a prior aborted transaction and wherein the transaction comprises one or more processor executable instructions.

Example 17 includes one or more examples, and includes a method comprising: causing a processor core to enter reduced power consumption state and based on a write to one or more of multiple memory regions, causing the processor core to exit reduced power consumption state, wherein the multiple memory regions store receive descriptors associated with one or more packets received by a network interface device.

Example 18 includes one or more examples, and includes the processor core executing a transaction that reads from the multiple memory regions.

Example 19 includes one or more examples, and includes aborting the transaction based on a prior abort of the transaction and wherein the transaction comprises one or more processor executable instructions.

Example 20 includes one or more examples, and includes based on exit from reduced power consumption state, the processor is to execute a packet processing process to process a packet associated with at least one or the receive descriptors.

What is claimed is:

1. An apparatus comprising:
circuitry to cause a processor to enter reduced power consumption state and circuitry to, based on a write to one or more of multiple memory regions, cause the processor to exit reduced power consumption state, wherein the multiple memory regions store receive descriptors associated with one or more packets received by a network interface device.

2. The apparatus of claim 1, wherein the multiple memory regions are defined by a driver of the network interface device.

3. The apparatus of claim 1, wherein the reduced power consumption state comprises a TPAUSE state.

4. The apparatus of claim 1, wherein the processor is to execute a transaction that reads from the multiple memory regions and wherein the transaction comprises one or more instructions.

5. The apparatus of claim 4, wherein the transaction commences at XBEGIN and ends at XEND.

6. The apparatus of claim 4, wherein the transaction is to abort based on a prior aborted transaction.

7. The apparatus of claim 4, wherein the transaction completes based on read from the multiple memory regions, no update to the multiple memory regions, and expiration of a timer.

8. The apparatus of claim 1, wherein based on exit from reduced power consumption state, the processor is to execute a packet processing process to process a packet associated with at least one or the receive descriptors.

9. The apparatus of claim 1, comprising a network interface device to indicate receipt of the one or more packets.

10. The apparatus of claim 9, comprising a data center comprising a server to transmit the one or more packets to the network interface device.

11. A computer-readable medium comprising instructions stored thereon, that if executed by one or more processors, cause the one or more processors to:
enter reduced power consumption state and
based on a write to one or more of multiple memory regions, exit reduced power consumption state, wherein the multiple memory regions store receive descriptors associated with one or more packets received by a network interface device.

12. The computer-readable medium of claim 11, wherein the multiple memory regions are defined by a driver of the network interface device.

13. The computer-readable medium of claim 11, wherein the reduced power consumption state comprises a TPAUSE state.

14. The computer-readable medium of claim 11, wherein, in reduced power consumption state, the one or more processors are to execute a transaction that reads from the multiple memory regions.

15. The computer-readable medium of claim 14, wherein the transaction commences at XBEGIN and ends at XEND.

16. The computer-readable medium of claim 14, wherein the transaction is to abort based on a prior aborted transaction and wherein the transaction comprises one or more processor executable instructions.

17. A method comprising:
causing a processor core to enter reduced power consumption state and
based on a write to one or more of multiple memory regions, causing the processor core to exit reduced power consumption state, wherein the multiple memory regions store receive descriptors associated with one or more packets received by a network interface device.

18. The method of claim 17, comprising:
the processor core executing a transaction that reads from the multiple memory regions.

19. The method of claim 18, comprising aborting the transaction based on a prior abort of the transaction and wherein the transaction comprises one or more processor executable instructions.

20. The method of claim 17, comprising based on exit from reduced power consumption state, the processor is to execute a packet processing process to process a packet associated with at least one or the receive descriptors.
